(19) United States
(12) Patent Application Publication
(10) Pub. No.: US 2003/0055916 A1
(43) Pub. Date: Mar. 20, 2003

(54) Method for requesting to receive the result of the remote execution of a function at a predetermined time

(76) Inventors: Youenn Fablet, Rennes (FR); Jean-Jacques Moreau, Rennes (FR)

Correspondence Address: FITZPATRICK CELLA HARPER & SCINTO, 30 ROCKEFELLER PLAZA, NEW YORK, NY, 10112, US

(21) Appl. No.: 10/232,405

(22) Filed: Sep. 3, 2002

(30) Foreign Application Priority Data
Aug. 31, 2001 (FR) 0111330

(51) Int. Cl. G06F 15/16

(52) U.S. Cl. 709/219

(57) ABSTRACT

This method of execution of a function by a server computer system on reception of an execution request from a client computer system, in a communication network, comprises the following steps:

extracting (S600) from the execution request at least one time of reception by the client of a first execution result of the function;

predicting (S620) a rate of transfer over the network substantially at the reception time;

determining (S620) a time for sending the first result to the client, the sending time being determined as a function of the reception time and of the rate of transfer;

executing (S655) the function and obtaining the first result;

sending the first result to the client substantially at the sending time.

The present invention relates to the field of computer communication networks in which computer programs are remotely executed.

More particularly, the invention concerns, on the one hand, a method for requesting to receive, at a predetermined time, the result of the execution of a function that is remotely executable, and on the other hand, a method of executing that function making it possible to provide the result of the execution at that time.

The invention also concerns devices capable of implementing the above-mentioned methods.

In the context of the present invention, the concept of “time” means a determined instant in time and is expressed for example in the form: day of the week, day of the month, and hour—or else in the form of a time limit with respect to a date or given moment in time.

In computer communication networks numerous computer systems are connected, such as personal computers, and processing peripherals such as printers, storage units, and means for the acquisition or storage of images or other types of documents.

The present invention applies more particularly to communication networks which define a communication protocol enabling the computers and peripherals to exchange requests and responses to those requests.

These networks use the principle known by the term “client-server” for the exchange of information between computer systems, designated here by the general term “station”. According to this principle, a so-called “client” station sends out a request for the execution of a function to a so-called “server” station which executes the function and sends back the result to the client station.

Client stations can be user systems, whereas server stations can be network servers dedicated to the execution of functions. However, each of the stations of the network under consideration may also be “client” or “server”.

Generally, there is a certain delay between the moment when a user makes a request from a client station for the execution of a function on a server station, and the moment when he receives the result of the execution of that function.

This delay, which comprises in particular the time for executing the function on the server computer system and the time of transferring the result of the execution from the server to the client, depends in particular:

on the workload of the computer server at the moment of executing the function; and

on the congestion and on the bandwidth of the communication network.

When this delay is long, it may waste time for the user who must wait for the result of the execution of the function in order to use it. Moreover, the longer the transfer time, the greater the risk of there occurring a breakdown of the network during the transfer, which would oblige the user to remake a request for the execution of the same function later.

Furthermore, the longer the transfer time, the greater the connection time to the server, which increases the financial cost of the connection to the network and/or to the server, where this cost is calculated according to the time of connection.

The invention aims to remedy these drawbacks by providing, according to a first aspect, a method of requesting by a first computer system at least one result of the execution of a function that is executable on a second computer system. In a communication network, characterized in that it comprises the following steps:

determining at least one reception time of a first execution result;

sending an execution request to the second computer system, the execution request comprising the reception time, with a view to receiving the first result substantially at the reception time.

In a complementary manner, the present invention also concerns a device for requesting at least one execution result of a function that is executable on a second computer system, it being possible to integrate the device into a first computer system, in a communication network, characterized in that it comprises:

means for determining at least one reception time of a first execution result;

means for sending an execution request to the second computer system, the execution request comprising the reception time, with a view to receiving the first result substantially at the reception time; and

means for receiving the first result.

The method and device set out above thus enable the scheduling of the reception time of the execution result of the function by the first computer system. Thus, when a communication protocol of client-server type is used, for example that known by the acronym HTTP (HyperText Transfer Protocol), the first computer system knows the time at which is can send out a request for obtaining the result.

According to a preferred embodiment of the invention, during the step of determining at least one reception time, two times for reception of the first result are determined, these two times delimiting a time slot for receiving the first result, the execution request comprising the reception time slot of the first result with a view to receiving the first result during the reception time slot.

This reception time slot thus advantageously provides a certain flexibility to the server which can therefore choose a time for sending the response according to the bandwidth available on the communication network.

According to another preferred embodiment of the invention, during the step of determining the reception time, a period for receiving of at least a second execution result of the function is further determined, the execution request comprising the period for receiving the second result, with a view to receiving in addition at least a second execution result of the function, during at least a second time slot for receiving the second result, two successive reception time slots being separated by the period for obtaining the second result.

In this manner, a single request enables several execution results of the function to be obtained at regular intervals. For example, in an application of the invention to a stock market information service, this feature can be used to periodically receive the changes of a given stock market value.

According to an advantageous feature of this preferred embodiment of the invention, during the step of determining a reception time, a criterion for stopping to send results by the second computer system is determined, the execution request comprising this stop criterion.

According to another preferred embodiment of the invention, the execution request is defined in XML language (eXtended Markup Language).

This embodiment is particularly advantageous, since it can be implemented in a great variety of types of terminal, and benefits from the very widespread communication infrastructure of the World Wide Web.

According to another preferred feature, the result received by the first computer system is liable to be an intermediate execution result of the function.

This feature, particularly advantageous when the duration of execution is long, enables information relating to the progress of the execution to be obtained. In particular, it may be used in the case of the archiving of large quantities of information.

According to another preferred feature, the result received by the first computer system is liable to comprise an information message.

The second computer system may thus notify the first computer system of the state of progress of the execution of the function or incidents in the execution.

According to a second aspect, the invention relates to a method of execution of a function by a second computer system on reception of an execution request from a first computer system, in a communication network, characterized in that it comprises the following steps:

extracting from the execution request at least one time of reception by the first computer system of a first execution result of the function;

predicting a rate of transfer over the network approximately at the reception time;

determining a time for sending the first result to the first computer system, the sending time being determined according to the reception time and of the rate of transfer;

executing the function and obtaining the first result;

sending the first result to the first computer system substantially at the sending time.

It is thus possible to calculate the sending time of the result of executing the function in order for this result to be received by the first computer system at the time specified in its request.

For example, the rate of transfer predicted at the reception time is obtained statistically from measurements of the average transfer rate, these measurements being made at instants regularly spaced with a predefined time interval.

In one embodiment, the step of executing the function is preceded by the steps of:

predicting an execution duration of the function applicable before the sending time;

determining an execution time of the function from the predicted execution duration and from the sending time, the execution being triggered substantially at the execution time.

For example, the predicted execution duration is calculated as a function of a workload of the second computer system applicable before the sending time and as a function of a minimum predetermined execution duration of the function.

This advantageously makes it possible to trigger the execution of the function at a moment when the workload of the second computer system is reduced.

For example, the workload of the second computer system can be calculated statistically from measurements of the average second computer system workload, these measurements being made at instants regularly spaced with a predefined time interval.

In another embodiment, the execution request comprises a time slot for reception of the first result, the reception time slot being delimited by two reception times, and the step of sending the first result is then preceded by:

a step of determining a sending time slot for the first result, from the reception time slot of the first result, the sending time slot being delimited by two sending times of the first result, each of these two sending times being obtained as previously from one of the two reception times delimiting the reception time slot;

the sending of the first result to the first computer system occurring during the sending time slot of the first result.

The second computer system can thus choose a sending time within the sending time slot for which the predicted rate of transfer over the communication network is minimum.

According to a particular feature, the step of executing the function is preceded by a step of determining a first time slot for execution of the function, the execution time slot being delimited by two execution times, each of which being obtained from the minimum duration of execution and from one of the two sending times, the execution of the function being triggered during the first execution time slot.

The second computer system may thus choose an execution time for the function for which its workload is minimum, while guaranteeing that the execution result of the function will be received by the first computer system during the reception time slot specified in his request.

According to another embodiment, the execution request further comprises a period for receiving at least a second execution result of the function; the execution method being remarkable in that:

at least a second time slot for receiving the second result is determined from the two reception times of the first result and from the reception period of the second result;

at least a second time slot for sending the second result is determined from the second reception time slot of the second result, in accordance with the step of determining a sending time slot of the first result;

at least a second time slot for executing the function is determined from the times delimiting the second sending time slot, according to the step of determining a first execution time slot;

the function is executed during the second execution time slot and at least a second execution result is obtained; and

the second execution result is sent to the first computer system during the second sending time slot.

In this manner, and as already described, a single request enables the second computer system to supply the first computer system with several execution results of the function at regular intervals.

According to a particular feature, the execution request further comprises a criterion for stopping to send results to the first computer system, and the sending of execution results is stopped as soon as the stopping criterion has been verified.

In practice, the stopping criterion is a number of executions of the function by the second computer system.

According to another particular feature, the method comprises a prior step of determining an earliest time of receiving the execution result of the function by the first computer system.

For example, the earliest reception time is determined from an execution end time calculated as a function of the current time, from the minimum predetermined execution duration of the function, from measurements of the workload of the second computer system, and from measurements of the transfer rate.

This particular feature makes it possible to determine if the second computer system is capable of supplying the execution result of the function at the time desired by the first computer system.

According to another particular feature, if the earliest reception time is later than the reception time, a result comprising an information message is sent to the first computer system.

In one embodiment, if the earliest reception time is later than the reception time:

an intermediate execution result of the function is obtained; and

this intermediate result is sent to the first computer system substantially at the reception time.

As a variant, if the earliest time is later than the reception time, the first computer system is asked if the execution of the function by the second computer system must be cancelled or continued with, and in this second case:

the function is executed as from the current time; and

the result of this execution is sent to the first computer system as soon as it is obtained.

Of course, only this variant can be used if the function does not make it possible to obtain any intermediate execution result.

In a complementary manner, the present invention also concerns a device for the execution of a function which may be integrated into a second computer system, the function being executed on reception of an execution request from a first computer system, in a communication network, characterized in that it comprises:

means for extracting from the execution request at least one time of reception by the first computer system of a first execution result of the function;

means for predicting a rate of transfer over the network substantially at the reception time;

means for determining a time for sending the first result to the first computer system, the sending time being determined as a function of the reception time and of the rate of transfer;

means for executing the function and obtaining the first result;

means for sending the first result to the first computer system substantially at the sending time.

In a complementary manner, the present invention also relates to a client station connected to a communication network, characterized in that it comprises a device for requesting function execution results, in accordance with the invention.

The invention also relates to a server station connected to a communication network, characterized in that it comprises a function execution device, in accordance with the invention.

The invention also relates to a computer comprising means adapted to implement the method or methods according to the invention as set out above.

The invention also relates to a computer program comprising one or more sequences of instructions capable of implementing the method or methods according to the invention as set out above, when this program is executed by a computer.

The invention furthermore relates to a data medium, such as a diskette or a compact disk (CD), characterized in that it contains such a computer program.

The advantages of these devices, stations, of this computer, of this computer program, and of this data medium are identical to those of the methods as succinctly set out above.

Other aspects and advantages of the invention will emerge from a reading of the following detailed description of a particular embodiment, given by way of non-limiting example. The description refers to the accompanying drawings, in which:

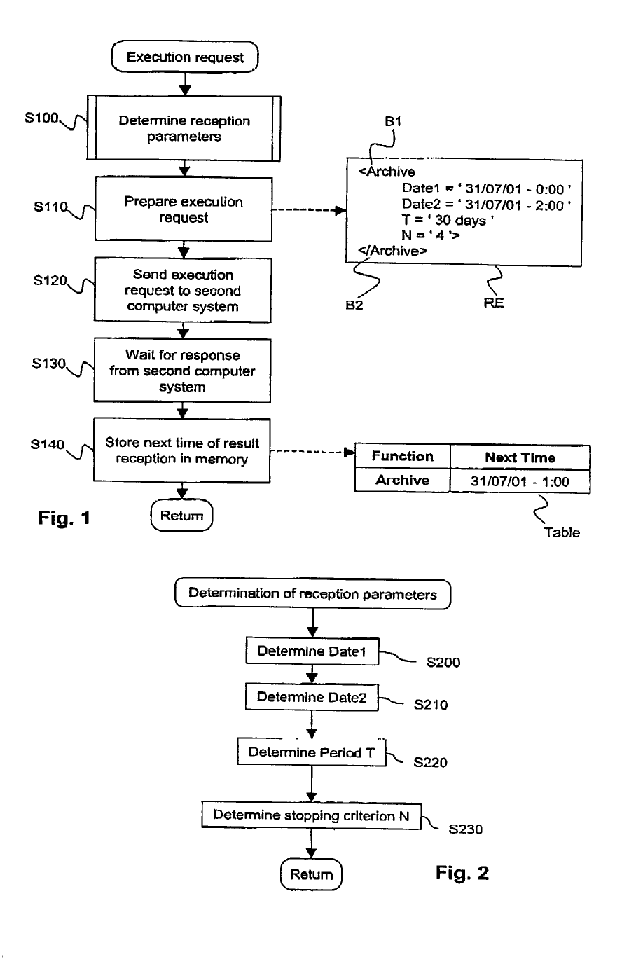

FIG. 1 is a flow diagram showing the main steps of a method of requesting execution by a first computer system, in a preferred embodiment of the invention;

FIG. 2 is a flow diagram showing the main steps of a procedure for determining reception parameters by the first computer system, in a preferred embodiment of the invention;

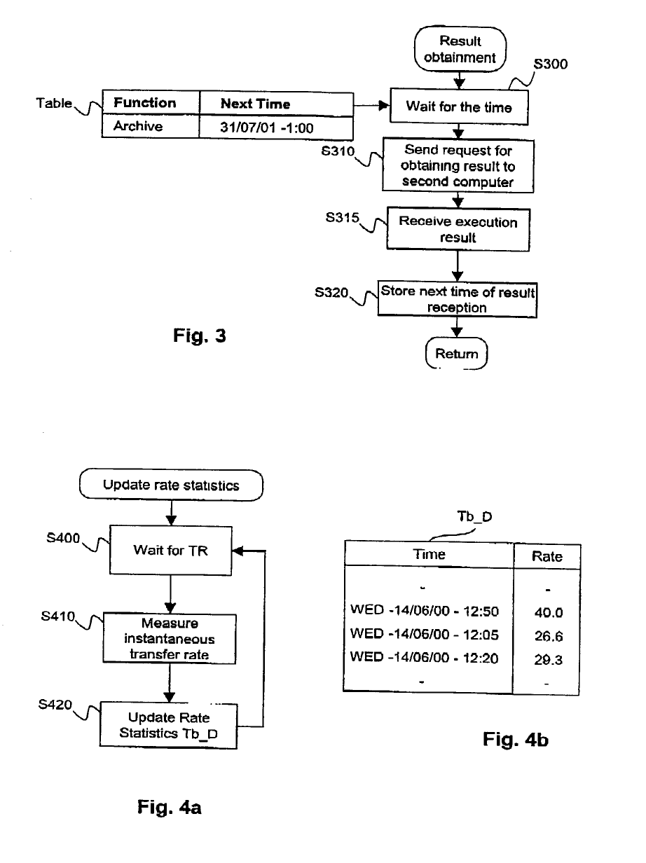

FIG. 3 is a flow diagram showing the main steps of a procedure for obtaining an execution result by the first computer system, in a preferred embodiment of the invention;

FIG. 4a is a flow diagram showing the main steps of a procedure for updating the transfer rate statistics by the second computer system, in a preferred embodiment of the invention;

FIG. 4b shows a table of the transfer rate statistics, in a preferred embodiment of the invention;

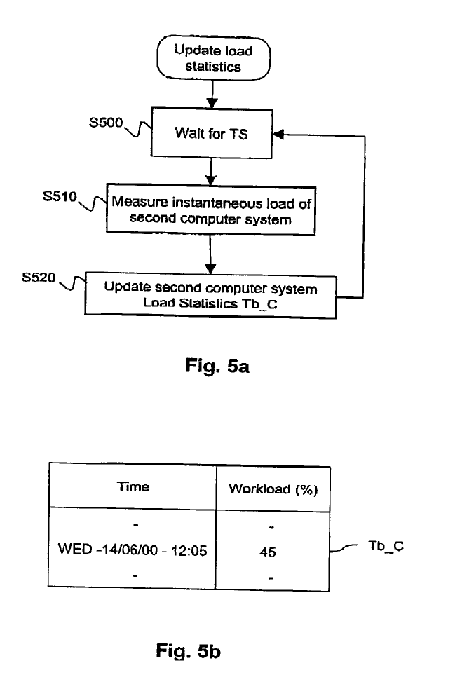

FIG. 5a is a flow diagram showing the main steps of a procedure for updating the statistics of the second computer system workload, by the second computer system, in a preferred embodiment of the invention;

FIG. 5b shows a table of the statistics of the second computer system workload, in a preferred embodiment of the invention;

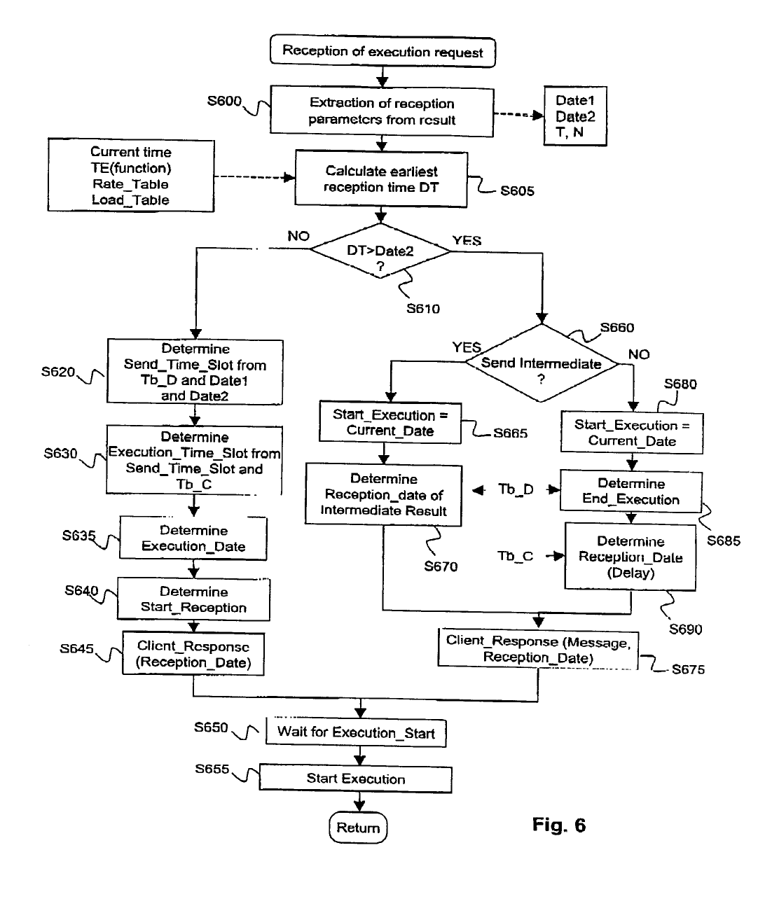

FIG. 6 is a flow diagram showing the main steps of a procedure for receiving an execution request by the second computer system, in a preferred embodiment of the invention;

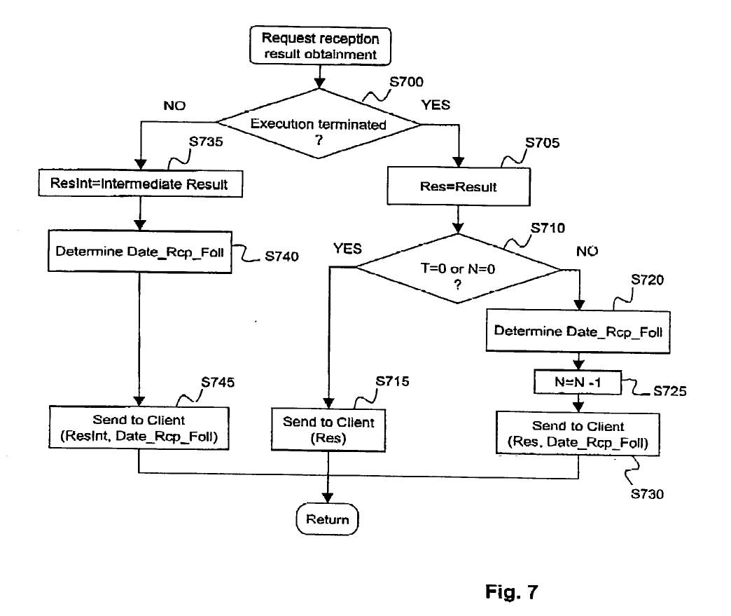

FIG. 7 is a flow diagram showing the main steps of a procedure for receiving an obtainment request by the second computer system, in a preferred embodiment of the invention;

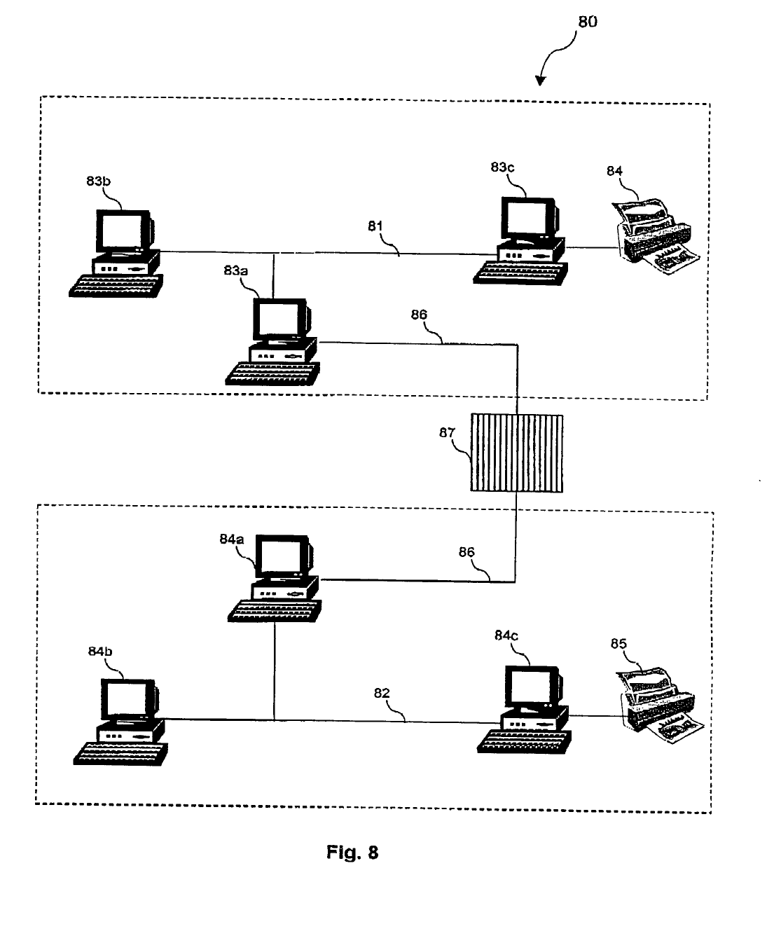

FIG. 8 shows a diagram of a network adapted to implement the invention;

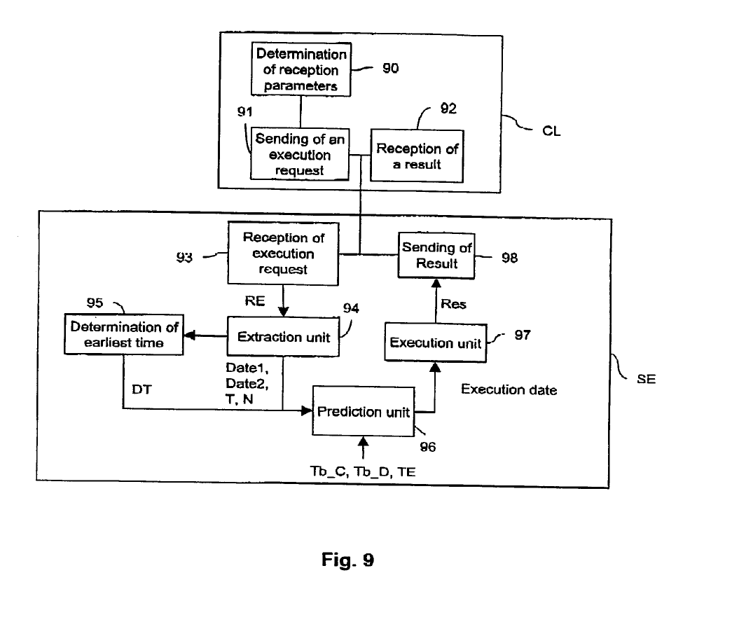

FIG. 9 shows a diagram of a device for requesting an execution result and an execution device according to the invention, in a preferred embodiment of the invention; and

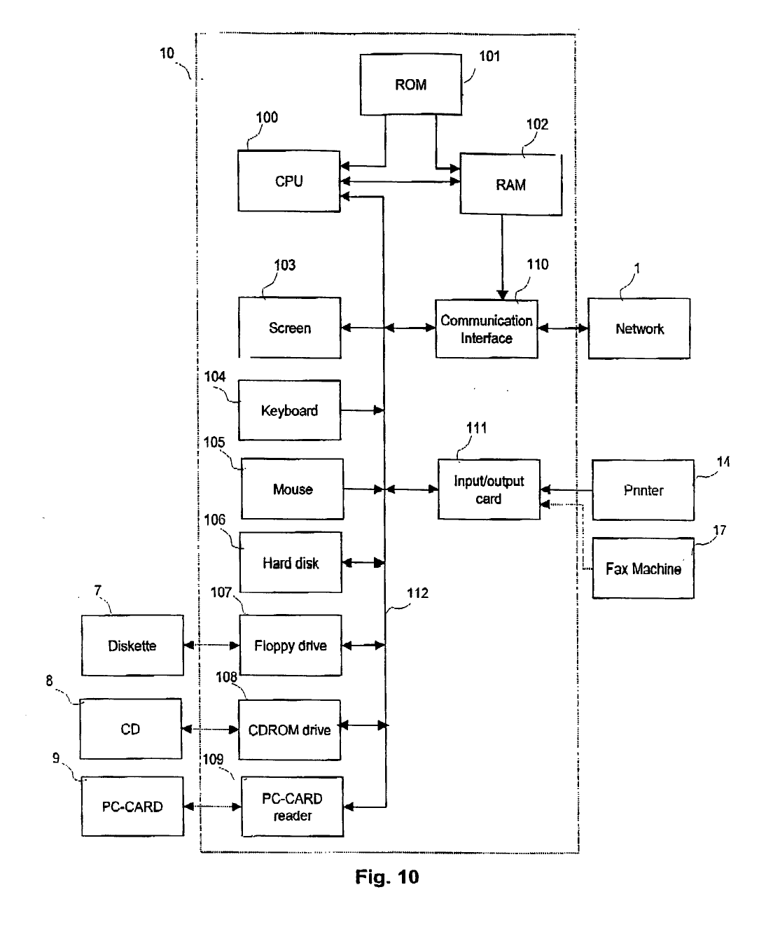

FIG. 10 shows a diagram of a computer adapted to incorporate the components making up the execution result requesting device and/or the execution device in a preferred embodiment of the invention;

FIG. 1 shows the steps S100 to S140 of a method for requesting execution by a first computer system in accordance with the invention.

The first step S100 is a step of invoking a procedure of determining reception parameters which will now be described with reference to FIG. 2.

FIG. 2 shows the main steps S200 to S230 of a procedure for determining reception parameters by the first computer system.

During a first step S200, a first time Date1 for receiving an execution result is determined.

This time Date1 is allocated to a variable Date1 stored in a register of the same name of a volatile RAM memory (102) which will be described later with reference to FIG. 10.

This time Date1 can be entered by the user of the first computer system, in particular by means of a keyboard (104) and a monitor (103) described with reference to FIG. 10.

In another embodiment of the procedure of obtaining reception parameters, this time Date1 can be predetermined and read in a register of a read only memory (101) of the first computer system.

Step S200 is followed by a step S210 during which a second time Date2 of reception of the execution result of the function may optionally be determined. This second reception time is allocated to the variable Date2 and stored in a register of the same name of the volatile RAM memory (102).

In a preferred embodiment, it is considered that when the time Date2 is not obtained at step S210, the variable Date2 is initialized with the content of the variable Date1.

Whatever the case, it will be stated subsequently that the two reception times Date1 and Date2 delimit a time slot for receiving the execution result of the function.

Step S210 is followed by a step S220 during which a period T for receiving at least a second execution result of the function is possibly determined.

This period T is allocated to a variable T stored in a register of the same name of the volatile RAM memory (102).

Where the period T is not obtained during step S220, the variable T is initialized to zero.

Step S220 is followed by a step S230 during which a criterion for stopping result sending by the second computer system may possibility be determined.

In the preferred embodiment, this stopping criterion corresponds to the number N of executions of the function by the second computer system, this variable N being stored in a register of the same name of the volatile RAM memory (102).

Step S230 is the last step of the procedure for obtaining reception parameters according to the invention. It is followed by the step S110 which will now be described with reference to FIG. 1.

During step S110, an execution request RE is prepared.

This execution request RE is stored in a register of the same name of the volatile RAM memory 102.

An example of an execution request RE is also given in FIG. 1.

In the preferred embodiment described here, the execution request RE is defined in XML language.

This execution request RE is delimited by an opening tag B1 and a closing tag B2.

The name of these tags corresponds to the name of the function executable on the second computer system.

In the example of FIG. 1, the name of this function is “Archive”, this function performing the archiving of files when it is executed by the second computer system.

The opening tag B1 comprises attributes corresponding to the reception parameters previously determined during the steps S210 to S230.

In the example of FIG. 1, these parameters are;

Date1=31/07/01-0:00;

Date2=31/07/01-2:00;

T=30 days;

N=4.

These parameters mean that the first computer system requests from the second computer system the execution of the function “Archive”, and wishes to obtain the first execution result of that function during the reception time slot delimited by Date1 and Date2, then to obtain four other execution results of that function in the reception time slots spaced apart from each other by 30 days.

Step S110 is followed by a step S120 during which the first computer system sends the execution request RE to the second computer system.

In a preferred embodiment, the sending of this execution request RE is carried out using the HTTP communication protocol.

As a variant, another communication protocol may be used, such as SMTP (Simple Mail Transfer Protocol) or BEEP (Blocks Extensible Exchange Protocol).

Step S120 is followed by a step S130 during which the first computer system waits for an acknowledgement from the second computer system.

This acknowledgement comprises, as described later with reference to FIG. 6, the reception time of the execution result of the function.

When the first computer system receives this acknowledgement, step S130 terminates. It is followed by step S140 during which the reception time of the result of the function received in the acknowledgement at step S130 is stored in a table Table.

An example of a table Table is given in FIG. 1.

It appears in this table Table that the next reception time of the result of the function archive is scheduled for the 31/07/01 1:00, this reception time being in fact contained in the reception time slot defined by the reception parameters Date1 and Date2, and contained in the execution request RE sent to the second computer system during step S120.

The step S140 is the last step of the method of requesting execution according to the invention.

We will now describe with reference to FIG. 3 the main steps S300 to S320 of a procedure for obtaining an execution result by the first computer system according to the invention.

During the first step S300, the content of the table Table updated during step S140 previously described is read.

More specifically, during this step S300, it is verified if the times stored in the table Table have been reached. This may be achieved, for example, by comparing the time stored in the table Table with the current time of the first computer system.

When this reception time of the execution result becomes due, step S300 terminates. This step is then followed by a step S310 during which a request for result obtainment is sent to the second computer system.

This request for result obtainment is also, in the preferred embodiment described here, defined in XML language and sent to the second computer system by means of HTTP protocol.

According to the variant previously described in which another communication protocol such as SMTP or BEEP is used, the sending of this obtainment request is not necessary.

Step S310 is followed by a step S315 during which the execution result of the function is received, this function having been executed by the second computer system.

The execution result of the function may be accompanied by a reception time of another execution result of the function,

either because the first computer system has requested the second computer system to obtain other execution results (N different to zero),

or because the result received is an intermediate execution result of the function.

Step S315 is followed by a step S320 during which, if the case arises and in a similar manner to step S140 already described, the reception time of another result received at the preceding step is stored in the table Table.

This step S320 is the last step of the result obtainment procedure.

With reference to FIG. 4a, a procedure for updating the transfer rate statistics will now be described, this procedure being implemented by the second computer system.

In the embodiment described here, the second computer system makes measurements of the average transfer rate over the communication network at regularly spaced apart intervals TR, these statistical measurements being stored in a table of transfer rate statistics Tb_D.

During the first step S400 of this procedure, the predefined time interval TR is awaited.

This step S400 is followed by a step S410 during which is calculated the transfer rate which was available, between the first computer system and the second computer system, during the time interval TR ending at the instant of the calculation.

Thus the available rate during a given interval of time TR is obtained by the calculation of the ratio between the quantity of data received by the second computer system during this interval of time and the value of this interval of time.

$$R a t e ( T R ) = \frac{Data\_received}{T R}$$

According to a preferred embodiment of the invention, the rate available at an instant tₙ is the quantity of data actually received by the first computer system between the successive instants tₙ₋₁ and tₙ.

In practice, the quantity of data actually received by the second computer system between the above-mentioned instants is obtained by the calculation of the difference between the total quantity of data received by the second computer system at the instant tₙ since the start of transfer, and the total quantity of data received by the first computer system at the instant tₙ₋₁ since the start of the transfer:

$$R a t e ( {t}_{n} ) = \frac{Data\_received ( {t}_{n} ) - Data\_received ( {t}_{n - 1} )}{{t}_{n} - {t}_{n - 1}}$$

Thus, by way of example, let us suppose on the one hand that the second computer system has received a data packet of which the size is 1.8 Megabytes (millions of bytes, 1 byte=8 bits), this data packet having been transferred on Jun. 14, 2000 between 11:35 a.m. and 12:20 p.m. (length of transfer: 45 minutes), and that, on the other hand, the measurement time interval is TR=15 minutes.

Measurement of the rate will then be made at the instants t₁=11:50, t₂=12:05, et t₃=12:20. Furthermore, note that t₀=11:45, the instant of the start of transfer.

If, for example, at the instant t₁ the quantity of data received by the first computer system is 0.45 Megabytes, at the instant t₂ the quantity of data received is 0.75 Megabytes, and at the instant t₃ the entire document has been received (1.8 Megabytes), we then will have:

$$R a t e ( {t}_{1} ) = \frac{Data\_received ( {t}_{1} ) - Data\_received ( {t}_{0} )}{{t}_{1} - {t}_{0}} = \frac{( 0.45 - 0.0 ) \times {10}_{6} \times 8}{15 \times 60} = 40.0 k b p s$$

$$R a t e ( {t}_{2} ) = \frac{Data\_received ( {t}_{2} ) - Data\_received ( {t}_{1} )}{{t}_{2} - {t}_{1}} = \frac{( 0.75 - 0.45 ) \times {10}_{6} \times 8}{15 \times 60} = 26.6 k b ps$$

$$R a t e ( {t}_{3} ) = \frac{Data\_received ( {t}_{3} ) - Data\_received ( {t}_{2} )}{{t}_{3} - {t}_{2}} = \frac{( 1.08 - 0.75 ) \times {10}_{6} \times 8}{15 \times 60} = 29.3 k b p s$$

It is therefore possible to say that the rate of transfer available for the data packet considered has been on average 40 kbps (kilo-bits per second) between 11:35 and 11:50, 26.6 kbps on average between 11:50 and 12:05, and 29.3 kbps on average between 12:05 and 12:20.

Step S410 is followed by a step S420 during which the measurement data are brought together and organized in the transfer rate statistics table Tb_D, as shown in FIG. 4b.

Step S410 is followed by step S400 already described, the steps S400 to S420 constituting a loop.

With reference to FIG. 5a, the main steps S500 to S520 of a procedure for updating the second computer system workload statistics will now be described, this procedure being implemented by the second computer system.

In the embodiment described here, the second computer system makes measurements of its average workload at regularly spaced-apart intervals TS, these statistical measurements being stored in a table of second computer system workload statistics Tb_C.

During the first step S500 of this procedure, the predefined time interval TS is awaited.

This step S500 is followed by a step S510 during which the second computer system workload is determined from the measurement of the extent of utilization of the central processing unit (CPU) of the second computer system, which may, for example, be constituted by one or more microprocessors.

Step S510 is followed by a step S520 during which the measurement data are brought together and organized in the second computer system workload statistics table Tb_C, as shown in FIG. 5b.

For example, it may be seen from the table Tb_C that the workload of the second computer system at the time “WED-14/06/00-12:05” is 45%.

With reference to FIG. 6 the main steps S600 to S690 will now be described of a procedure for receiving an execution request RE by the second computer system.

This procedure begins when the second computer system receives the execution request RE sent by the first computer system during step S120.

During the first step S600, the reception parameters of the results are extracted from the execution request RE.

These parameters were inserted in the execution request RE during step S110 by the first computer system and correspond to the variables Date1, Date2, T and N.

Step S600 is followed by a step S605 during which the earliest reception time DT is calculated for reception of the execution result by the first computer system.

This earliest reception time DT is obtained by considering that the function is executed on reception of the execution request RE, that is to say at the current time.

In order to obtain that earliest reception time DT, the execution duration of the function is predicted by assuming therefore that the execution of that function is started at the current time. To predict this execution duration, there is used:

on the one hand, a minimum predetermined execution duration TE of that function, this minimum predetermined duration TE being the actual execution duration of the function by the second computer system when all the processing resources of the second computer system are used for the execution of that function;

and on the other hand, the table of the second computer system workload statistics Tb_C, this table Tb_C enabling in particular to predict the processing resources of the second computer system that are available at the current time.

The estimation of the future workload of the second computer system according to the invention relies on the hypothesis according to which the utilization of the second computer system varies very little from one week to the next. Thus the available workload predictable for a day to come, at a given time, will be very little different (on average) to that observed the same day (and at the same time) for the previous week.

Thus the value predicted for the workload of the second computer system available at a future time is considered to be equal to the value of the workload calculated at an “equivalent time” within the week preceding week.

Supposing, for example, that the minimum predetermined execution duration TE of the archiving function is 1 hour and that the percentage of processing resources of the second computer system available at the current time is 50%, then the execution duration that will be predicted for the function applicable at the current time is two hours.

Still during this step S605, after the prediction of the execution duration of the function, the earliest reception time DT is determined, by assuming that the result of the function is sent to the first computer system on termination of the execution of the function.

For this purpose, a presumed transfer duration is determined by using the table of transfer rate statistics Tb_D.

In the same way, according to the invention, the value predicted for the transfer rate available at a future time is considered to be equal to the value of the transfer rate calculated at an “equivalent time” within the week preceding week.

Assuming that the predictable transfer rate of the execution result of the function between the second computer system and the first computer system at the end of the execution is 15 minutes, it will be predicted that the earliest reception time DT of the execution result of the function is the current time plus 2 hours and 15 minutes.

Step S605 is followed by a test S610 during which it is verified if the earliest reception time DT calculated at step S605 is greater than the time Date2 extracted from the execution request RE.

If this is not so, it means that the second computer system is able to execute the function and to send the execution result of the function such that the result will be received by the first computer system before the end of the reception time slot delimited by Date1 and Date2. In this case, the result of the test S610 is negative.

This test is then followed by a step 8620 during which a time slot for sending the execution result of the function is determined, this sending time slot being determined from the reception time slot delimited by Date1 and Date2 and from the table of transfer rate statistics Tb_D.

For this, on the one hand the transfer rates substantially applicable at Date1 and Date2 are looked at in the table of transfer rate statistics Tb_D.

From these transfer rates and from the size of the execution result of the function, the transfer durations for this result on the communication network are determined substantially applicable at Date1 and Date2.

Next, the sending times of the execution result of the function are determined such that the result is received by the first computer system at the times Date1 and Date2, these sending times delimiting the sending time slot.

Step S620 is followed by a step S630 during which an execution time slot is determined, this execution time slot being determined from the sending time slot determined at the preceding step, and from the second computer system workload statistics table Tb_C.

For this, the second computer system workload applicable substantially at the times delimiting the sending time slot are read in the second computer system workload statistics table Tb_C.

From these workloads and from the minimum predetermined execution duration TE of the function, the execution duration of that function is predicted, and two execution times of that function are determined such that if the execution of that function is begun at these times, the execution will be terminated substantially at the times delimiting the sending time slot for the result.

These two execution times delimit the execution time slot of the function.

Step S630 is followed by a step S635 during which the start of execution of the function is determined.

This step S630 consists more specifically in determining the execution time of the function enabling the execution time of the function and/or the transfer time of the execution result of the function to the first computer system to be reduced.

This time of commencing the execution is of course included within the execution time slot determined at step S630.

In a first variant, this time of commencement of execution is determined in order to spread out the workload of the second computer system as well as possible over time.

In other variants, it would be possible to try to minimize:

the transfer duration of the execution result; or

the total duration corresponding to the execution duration and to the transfer time of the result.

Step S635 is followed by a step S640 during which the reception time of the result of the function is determined from the time of commencement of execution chosen at step S635. This is carried out by determining initially the time of the end of execution of the function from the second computer system workload statistics table Tb_C and from the minimum predetermined execution duration TE, and by determining on the other hand the transfer duration of the execution result of the function from the table of statistics Tb_C of transfer commencement.

Step S640 is followed by a step S645 during which the second computer system sends an acknowledgment to the first computer system. This acknowledgment is awaited by the first computer system during step S630 already described.

This acknowledgment comprises the reception time of the execution result of the function by the first computer system, this time having been determined during step S640.

The sending of this acknowledgment is carried out in the preferred embodiment described here by the sending of a message defined in XML language, the sending of this message being carried out using the HTTP communication protocol.

Step S645 is followed by a step S650 during which the second computer system awaits the time of the start of execution of the function determined during step S635.

This step S650 is then followed by a step S655 during which the second computer system starts the execution of the function. This step S645 is the last step of the procedure of receiving an execution request RE by the second computer system.

Returning to the test S610, when the earliest reception time DT calculated at step S605 is greater than the time Date2 extracted from the execution request RE, the result of this test is positive.

This means that the second computer system is unable to execute the function and to send the execution result of the function such that the result will be received by the first computer system during the reception time slot delimited by Date1 and Date2.

The test S610 is then followed by a test S660 during which it is verified if, in this particular case, the second computer system must:

send an intermediate execution result to the first computer system during the receiving time slot;

execute the function and supply an execution result as soon as possible: or

cancel the execution of the function. This third case will not be described here.

In a preferred embodiment, each function executed on the second computer system is associated with an attribute specifying if it is able to supply an intermediate execution result or not.

If such is the case, the result of the test S660 is positive. This test is then followed by a step S665 during which the current time is attributed to the time of commencement of execution of the function.

Step S665 is followed by a step S670 during which the time of receiving the intermediate result by the first computer system is determined from this time of commencement of execution.

This is carried out by selecting, in the table of transfer rate statistics Tb_D, a time of receiving the intermediate execution result of the function such that the transfer rate on the communication network at that time is low.

Step S670 is followed by step S675 which is similar to step S645 already described.

During this step S675, the second computer system sends a message of acknowledgment to the first computer system containing on the one hand the reception time determined at step S670, and on the other hand, a message indicating to the first computer system that the execution result received at that reception time will be an intermediate execution result of the function.

Step S675 is followed by the step S650 of awaiting the start of execution of the function. In this case, the duration of this step is nil since it was planned at step S665 to commence the execution of the function at the current time.

Returning to the test S660, when it is planned for the second computer system to send the final execution result of the function to the first computer system as soon as the result is obtained, (outside the receiving time slot delimited by Date1 and Date 2), the result of the test S660 is negative.

This test 8660 is then followed by a step S680 during which the current time is attributed to the time of commencement of execution of the function. This step S680 is similar to the step S665 already described.

This step S680 is followed by a step S685 during which the time of the end of execution of the function is determined assuming that the commencement of the execution of the function starts at the current time. This end of execution time is determined from the second computer system workload statistics table Tb_C.

Step S685 is followed by a step S690 during which the reception time of the final execution result of the function is determined assuming that the sending of this result to the first computer system takes place on termination of the execution of the function.

This time of reception is determined from the table of transfer rate statistics Tb_D.

Step S690 is then followed by step S675 already described, in which the acknowledgement message to the first computer system contains a part of the reception time determined at step S690, and furthermore, a message indicating to the first computer system that the execution of the function is in course.

With reference to FIG. 7 the main steps S700 to S745 will now be described of a procedure for receiving a request for result obtainment, these steps being implemented by the second computer system.

This procedure begins when the second computer system receives the request for result obtainment sent by the first computer system during step S310.

During a first step S700 it is verified if the execution of the function is terminated.

If such is the case, the execution result of that function is attributed to a variable Res, this variable being stored in a register of the same name of the volatile RAM memory (102).

Step S705 is followed by a test S710 during which it is verified if at least one of the variables T and N extracted from the execution request during step S600 is nil.

If such is the case, this means that the execution of the function which has just terminated was the last execution associated with the request in course of being processed.

The result of the test S710 is then positive. This test is followed by a step S715 during which the result of execution of the function is sent to the first computer system.

On the other hand, if the variables T and N are not nil, this means that at least one result of another execution the function must be sent to the first computer system.

The result of the test S710 is then negative. This test is followed by a step S720 during which the reception time of the following execution result is determined.

This determination is carried out in a similar manner to the determination of the reception time already described, by replacing the receiving time slot delimited by Date1 and Date2 by a receiving time slot delimited by times Date1′ and Date 2′ such that:

Date1′=Date1+T and

Date2′=Date2+T.

Step S720 is followed by a step S725 during which the variable N is decremented by one unit.

Step S725 is followed by a step S730 during which there is sent to the first computer system on the one hand the execution result of the function Res, and on the other hand the reception time of the following execution result of the function.

When, during the test S700, the execution of the function is not terminated, the result of this test is negative.

This test is then followed by a step S735 during which an intermediate execution result of the function is obtained, this intermediate result being attributed to a variable Resint, this variable being stored in the volatile RAM memory (102).

Step S735 is followed by a step S740 during which the time of reception by the first computer system of the following execution result of the function is determined, where this reception time may be either another intermediate execution result of the function, or the final execution result of the function. This determination is carried out in a similar manner to the determination of the first reception time as already described.

Step S740 is followed by a step S745 during which there is sent to the first computer system on the one hand the intermediate result, and on the other hand the following reception time of the execution result of the function.

Steps S715, S730 and S745 terminate the procedure of reception of a request for result obtainment.

With reference to FIG. 8, an example of a network adapted to implement the invention will now be described.

The network 80 comprises in reality two sub-networks 81, 82. Each of the sub-networks comprises a plurality of computers and peripherals connected together over the network. By way of example, the sub-networks 81 and 82 can be local networks (LAN) based on known architectures such as Ethernet or Token Ring, or else enterprise networks connected together via a telephone network.

Thus in this example, the sub-network 81 comprises three computers 83a, 83b and 83c and a printer 84 connected to the sub-network 81 via the computer 83c.

The second sub-network 82 comprises three computers 84a, 84b and 84c and a printer 85 connected to the sub-network 82 by the computer 84c.

These two sub-networks 81 and 82 are connected via the computers 83a and 84a, belonging respectively to the first sub-network 81 and to the second sub-network 82, each of these computers 83a, 84a incorporating a modem, these modems being connected via a telephone communication network 86, and by way of example via a switching unit 87 which is located with the same service provider common to both networks 81, 82.

This structure enables the two sub-networks 81 and 82 to communicate, such that a user of the first sub-network 81 can use the elements of the second sub-network 82 as if they physically belonged to the first sub-network 81, and vice-versa.

The sub-networks 81 and 82 can also be integrated into a planetary communication network, such as the Internet network, constructed above a communication protocol enabling the computers connected to the network to communicate (for example HTTP).

For each of these sub-bands the Internet access is obtained for example via the telephone communication network 86.

By way of example, the first and second computer systems mentioned previously are respectively the computers 83b, and 84b. They will be described later with reference to FIG. 10.

With reference to FIG. 9 a device CL for requesting an execution result of a function and a device SE for executing that function according to the present invention will now be described.

The device CL for requesting an execution result of a function comprises a unit 90 for determining reception parameters.

This unit 90 for determining reception parameters makes it possible to determine at least one time Date1 for receiving an execution result and possibly:

a second time Date2 for receiving the execution result of the function;

a period T for receiving at least a second execution result of the function; and

a criterion N for stopping to send results by the second computer system.

The device CL for requesting an execution result of a function also comprises a unit 91 for sending an execution request RE.

This unit 91 for sending an execution request RE is capable of creating, in XML language, an execution request RE from reception parameters determined by a unit 90 for determining reception parameters.

This unit 91 for sending a request is also adapted to send the execution request RE to the second computer system according to a communication protocol, for example HTTP.

The device CL for requesting an execution result of a function also comprises a unit 92 for receiving an execution result of the function from the second computer system.

This unit 92 for reception of a result is also capable of verifying if the times stored in the table Table become due and of sending a request for result obtainment to the second computer system when this is the case.

Generally, the device CL for requesting an execution result of a function comprises means adapted to implement the method of requesting execution results of a function described previously with reference to FIGS. 1 to 3.

The device SE for executing a function comprises a unit 93 for receiving an execution request RE.

This unit 93 for receiving an execution request is in particular adapted to communicate with the unit 91 for sending a request of the device CL, for example by means of the HTTP communication protocol.

The device SE for executing a function also comprises a unit 94 for extracting reception parameters from the execution request RE received by the reception unit 93, these parameters having been determined in the device CL by the parameter determination unit 90.

The device SE for executing a function also comprises a unit 95 for determining an earliest reception time DT of the execution result by the first computer system.

This determination unit 95 is in particular capable of implementing step S605 previously described with reference to FIG. 6.

The device SE for executing a function also comprises a prediction unit 96.

This prediction unit 96 is in particular capable of predicting a transfer rate over the communication network and a duration of execution of the function substantially at a given time.

In a preferred embodiment these predictions are carried out statistically by periodic measurements respectively of the average transfer rate over the network and of the average load of the second computer system.

Prediction unit 96 is also capable of determining a time for sending a result to the first computer system as a function of a desired reception time and of a predicted transfer rate, as well as an execution time of the function from a predicted execution duration and from a sending time.

The device SE for execution of a function also comprises an execution unit 97 capable of starting the execution of a function at a given execution time, and of obtaining intermediate or definitive execution results of that function at set times.

The device SE for execution of a function also comprises a unit 98 for sending the execution result of a function to the unit 92 for receiving an execution result of the first computer system.

Generally, the device SE for executing a function comprises means adapted to implement the method of executing a function described previously with reference to FIGS. 4a to 7.

With reference now to FIG. 10, a computer will now be described which is adapted to incorporate the components making up the execution result requesting device and/or the execution device according to the invention.

In this embodiment, the means constituting the device for requesting at least one execution result of a function and the device for executing a function according to the invention are essentially software or program components.

Consequently, these software components comprise one or more sequences of instructions of which the execution by said computer enables the implementation of the methods according to the invention.

In FIG. 10, the computer 10 which may typically be a microcomputer or a workstation, comprises in a typical manner a central processing unit (CPU) 100, connected to a read-only memory (ROM) 101 and to a random access memory RAM (102), as well as to a data bus 112.

The communication bus 112 enables communication between the different sub-elements of the computer 10, or the elements connected to it. However, the communication between the different sub-elements of the computer is not limited to the bus 112. In particular, the central processing unit 100 is liable to communicate instructions to any sub-element of the computer 10 directly or by means of another sub-element of the computer 10.

The computer 10 comprises a communication interface 110 connected to a communication network such as the network 80 (shown in FIG. 8) such as the Internet network and capable of receiving and transmitting data for example using the HTTP protocol. This communication interface 110 comprises for example a modem of type known to the person skilled in the art.

The computer 10 also typically comprises a storage means 106 such as a hard disk. It may also comprise a floppy drive 107, a CD-ROM drive 108 and a reader 109 of cards of so-called PC-CARD format.

A diskette 7, a compact disk (CD) 8, a card 9 of PC-CARD type, adapted to be read respectively by the floppy drive 107, the CD-ROM drive 108 and the card reader 109; as well as the hard disk 106, can be used for the storage of documents transferred according to the invention, as well as for the storage of the software code enabling the implementation of the method of transfer according to the invention.

According to a preferred embodiment, the executable code of the program enabling the implementation of the method of transfer is stored on the hard disk 106.

According to a variant form, the executable code of this program is stored in the ROM 101.

According to another variant form, the executable code of the program may be downloaded from the communication network 1 via the communication interface 110 in order to be stored on the hard disk 106.

The communication interface 110 is for example a web browser.

On execution of the program, the created and modified variables are stored in the registers of the RAM (102)

The computer 3 further comprises a screen 103 able to serve as graphical interface between the program according to the invention and the user, the latter being able to formulate requests with the use of a pointing device such as a mouse 105, or else with the use of a keyboard 104.

The computer 10 further comprises various peripherals, such as a printer 14 enabling for example downloaded documents to be printed, or a fax machine 17. These peripherals are connected to the computer via an input/output card 111.

Naturally, numerous modifications can be made to the embodiments of the invention described above without leaving the scope of the invention.

1. A method of requesting, by a first computer system, at least one execution result of a function that is executable on a second computer system, in a communication network, comprising the following steps:
determining at least one reception time of a first execution result;
sending an execution request to the second computer system, the execution request comprising said at least one reception time, with a view to receiving said first result substantially at said reception time.

2. A method according to claim 1, wherein, during said step of determining at least one reception time, two times for reception of said first result are determined, these two times delimiting a time slot for receiving said first result, said execution request comprising said reception time slot of said first result with a view to receiving said first result during the reception time slot.

3. A method according to claim 2, wherein, during said step of determining at least one reception time, a period for receiving of at least a second execution result of said function is further determined, said execution request comprising said period for receiving said at least a second result, with a view to receiving in addition at least a second execution result of said function, during at least a second time slot for receiving said at least a second result, two successive reception time slots being separated by said period for obtaining said at least a second result.

4. A method according to claim 3, wherein, during said step of determining at least one reception time, a criterion for stopping to send results by said second computer system is determined, said execution request comprising said stop criterion.

5. A method according to claim 1, wherein said execution request is defined in XML language.

6. A method according to claim 1, wherein a result received by the first computer system is liable to be an intermediate execution result of said function.

7. A method according to claim 1, wherein a result received by the first computer system is liable to comprise an information message.

8. A method of execution of a function by a second computer system on reception of an execution request from a first computer system, in a communication network, comprising the following steps:
extracting from said execution request at least one time of reception by the first computer system of a first execution result of said function;
determining a time for sending said first result to said first computer system, said sending time being determined as a function of said at least one reception time and of said rate of transfer;
executing said function and obtaining the first result;
sending said first result to said first computer system substantially at said sending time.

9. A device for requesting at least one execution result of a function that is executable on a second computer system, it being possible to integrate said device into a first computer system, in a communication network comprising:
means for determining at least one reception time of a first execution result;
means for sending an execution request to the second computer system, the execution request comprising said at least one reception time, with a view to receiving said first result substantially at said reception time; and
means for receiving said first result.

10. A device for execution of a function which may be integrated into a second computer system, said function being executed on reception of an execution request from a first computer system, in a communication network, comprising:
means for extracting from said execution request at least one time of reception by said first computer system of a first execution result of said function;
means for determining a time for sending said first result to said first computer system, said sending time being determined as a function of said at least one reception time and of said rate of transfer;
means for executing said function and for obtaining said first result;
means for sending said first result to said first computer system substantially at said sending time.

11. A client station connected to a communication network, comprising a device for requesting at least one execution result of a function, according to claim 9.

12. A server station connected to a communication network, characterized in that it comprises a device for executing a function, according to claim 10.
